(19) United States
(12) Patent Application Publication
(10) Pub. No.: US 2025/0242705 A1
(43) Pub. Date: Jul. 31, 2025

(54) DUAL DYNAMIC WIRELESS CHARGING

(71) Applicant: UT-Battelle, LLC, Oak Ridge, TN (US)

(72) Inventors: Vivek Anand Sujan, Knoxville, TN (US); Burak Ozpineci, Knoxville, TN (US); Omer Caglar Onar, Knoxville, TN (US); David E. Smith, Oak Ridge, TN (US)

(21) Appl. No.: 19/038,006

(22) Filed: Jan. 27, 2025

Related U.S. Application Data
(60) Provisional application No. 63/626,083, filed on Jan. 29, 2024.

(51) Int. Cl. B60L 53/12; B60L 53/36; B60L 53/53; B60L 53/54; B60L 58/12; H01M 10/44; H02J 7/00; H02J 50/10; H02J 50/40; H02J 50/80; H02J 50/90

(52) U.S. Cl. CPC B60L 53/12; B60L 53/36; B60L 53/53; B60L 53/54; B60L 58/12; H01M 10/44; H02J 7/00712; H02J 50/10; H02J 50/40; H02J 50/80; H02J 50/90; B60L 2240/54; H01M 2220/20

(57) ABSTRACT

A dual dynamic wireless charging system for battery-dominant vehicles is provided, including for example battery electric vehicles (BEVs), fuel cell electric vehicles (FCEVs), and hybrid-electric vehicles (HEVs). The dynamic wireless charging system includes a transmitter coil installed on a transmitter vehicle, the transmitter coil being inductively coupled to a receiver coil installed on a receiver vehicle. Power transfer is achieved wirelessly while both vehicles are in motion, such that the receiver vehicle does not come off-mission. The transmitter vehicle and the receiver vehicle can travel in a side-by-side configuration, being parallel to each other in adjacent lanes. In other embodiments, a lead-and-follow configuration is used in place of a side-by-side configuration. Vehicle-to-vehicle communications ensure rapid adjustments to speed and trajectory, allowing seamless alignment despite variations in roadway conditions and traffic.

### CROSS-REFERENCE TO RELATED APPLICATIONS

This application claims the benefit of U.S. Provisional Application 63/626,083, filed Jan. 29, 2024, the disclosure of which is incorporated by reference in its entirety.

### STATEMENT REGARDING FEDERALLY SPONSORED RESEARCH AND DEVELOPMENT

This invention was made with government support under Contract No. DE-AC05-00OR22725 awarded by the U.S. Department of Energy. The government has certain rights in the invention.

### BACKGROUND OF THE INVENTION

The present invention relates to wireless charging for battery-dominant electric vehicles. Wireless charging is an appealing concept that avoids the need for mechanical connectors. In its earliest manifestation, wireless charging was done statically, in that a vehicle would arrive at a charging station and park itself in direct alignment for the receiving and transmitter coils. However, this charging methodology requires the vehicle to come off-mission until charging is complete. Static or stationary charging has since evolved to include dynamic charging, in which moving vehicles are charged from transmitter coils embedded in the roadway. As a parallel to dynamic charging, the use of overhead catenary wires has been explored for contact-based energy transfer to moving vehicles. While this approach addresses many of the challenges found in static charging systems, it introduces several infrastructure challenges, including cost. Accordingly, there remains a continued need for an improved charging system for battery-dominant electric vehicles, and in particular, charging systems that reduce dependency on traditional charging stations and that minimize or eliminate vehicle downtime.

### SUMMARY OF THE INVENTION

A dual dynamic wireless charging system for battery-dominant vehicles is provided. The dynamic wireless charging system includes a transmitter coil installed on a transmitter vehicle, the transmitter coil being inductively coupled to a receiver coil installed on a receiver vehicle. Power transfer is achieved wirelessly while both vehicles are in motion, such that the receiver vehicle does not come off-mission. The transmitter vehicle and the receiver vehicle can travel in a side-by-side configuration, being parallel to each other in adjacent lanes. In other embodiments, a lead-and-follow configuration is used in place of a side-by-side configuration. Vehicle-to-vehicle communications ensure timely adjustments to speed and trajectory, allowing seamless alignment despite variations in roadway conditions and traffic.

In these and other embodiments, the dual dynamic wireless charging system employs principles of electromagnetic induction to transfer energy without direct physical contact. Because the transmitter vehicle is functionally a mobile charging station, the dual dynamic wireless charging system can operate while both vehicles are in motion, reducing dependency on traditional charging stations. This approach eliminates the need for extended charging stops, thereby enhancing operational efficiency and maximizing uptime for logistics operations. The present invention is particularly well-suited for heavy-duty commercial freight. By pre-positioning transmitter vehicles along an intended freight route, heavy-duty trucks can maintain smaller onboard batteries, reducing weight and increasing cargo capacity. Off-highway applications are also contemplated. While primarily directed to freight transport, embodiments of the invention are also well-suited for public transit and passenger vehicles.

These and other features and advantages of the present invention will become apparent from the following description of the invention, when viewed in accordance with the accompanying drawings and appended claims.

### BRIEF DESCRIPTION OF THE DRAWINGS

FIG. 1 illustrates a dual dynamic wireless charging system including a transmitter vehicle and a receiver vehicle in a side-by-side configuration.

FIG. 2 illustrates a dual dynamic wireless charging system including a transmitter vehicle and a receiver vehicle in a lead-and-follow configuration.

FIG. 3 illustrates a dual dynamic wireless charging system including a transmitter vehicle and two receiver vehicles.

FIG. 4 is a system block diagram of certain componentry of a transmitter vehicle for use with embodiments of the present invention.

FIG. 5 is a system block diagram of certain componentry of a receiver vehicle for use with embodiments of the present invention.

FIG. 6 is a flow chart illustrating a method of dual dynamic wireless charging according to one embodiment of the invention.

### DETAILED DESCRIPTION OF THE CURRENT EMBODIMENT

The current embodiment relates to a dual dynamic wireless charging system for battery-dominant vehicles, for example battery electric vehicles (BEVs), fuel cell electric vehicles (FCEVs), and hybrid-electric vehicles (HEVs). As discussed below, the dual dynamic wireless charging system includes a transmitter coil installed on a transmitter vehicle, the transmitter coil being inductively coupled to a receiver coil installed on a receiver vehicle. The transmitter vehicle is functionally a mobile charging station, such that power transfer is achieved wirelessly while both vehicles are in motion. Vehicle-to-vehicle communications ensure timely adjustments to speed and trajectory, such that the transmitter vehicle and the receiver vehicle travel in a side-by-side configuration and/or a lead-and-follow configuration during wireless power transfer.

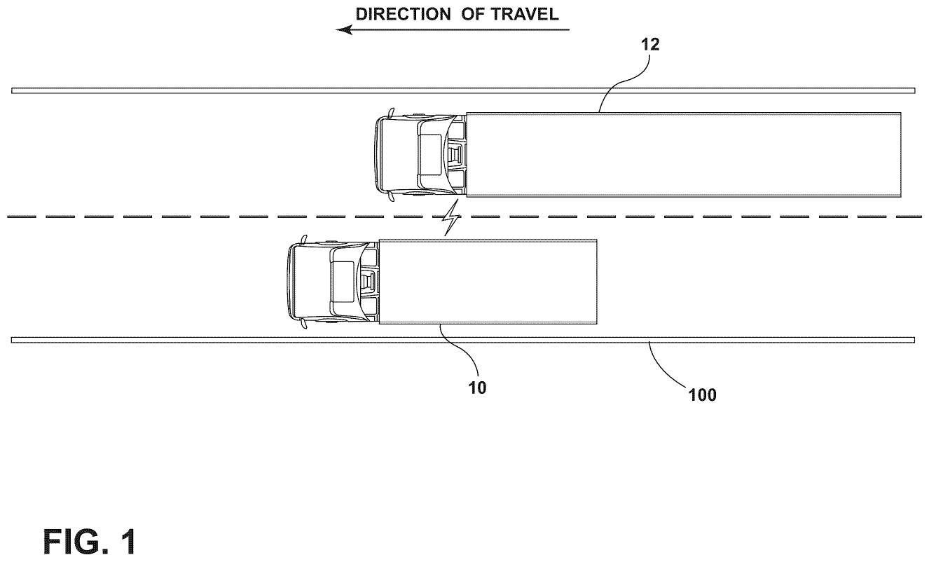

As shown in FIG. 1, for example, the transmitter vehicle 10 and the receiver vehicle 12 traverse a roadway 100 in a common direction. The vehicles coordinate via a communication system, discussed below, to initiate the charging process. The transmitter vehicle 10 is equipped with a wireless power transfer system, while the receiver vehicle 12 is equipped with a compatible wireless charging receiver to accept energy wirelessly. As illustrated, the transmitter vehicle 10 maneuvers to travel in close proximity to the receiver vehicle 12 in an adjacent lane in a side-by-side configuration. Wireless power transfer commences in response to the inter-vehicle distance being within acceptable parameters, in response to the relative velocity of the two vehicles being less than a threshold value, and in response to the footprint of a transmitter coil overlapping all or a portion of the footprint of a receiver coil. The transmitter vehicle 10 optionally includes an advanced driver-assistance system (ADAS) to maintain a safe and stable distance from the receiver vehicle, functioning to synchronize speed and trajectory for uninterrupted charging. Once the receiver vehicle 12 is fully charged, the transmitter vehicle 10 disengages and continues to the next vehicle, optionally as part of a vehicle convoy.

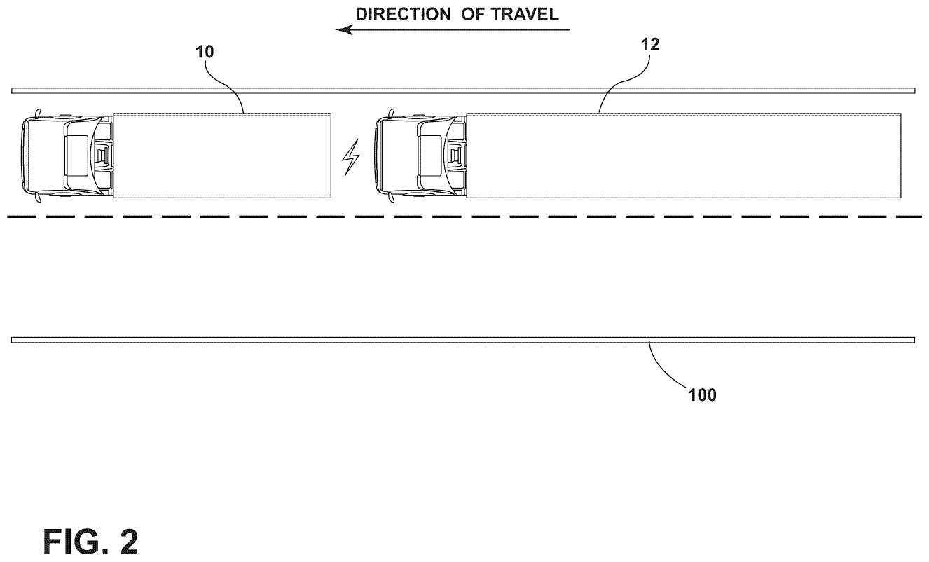

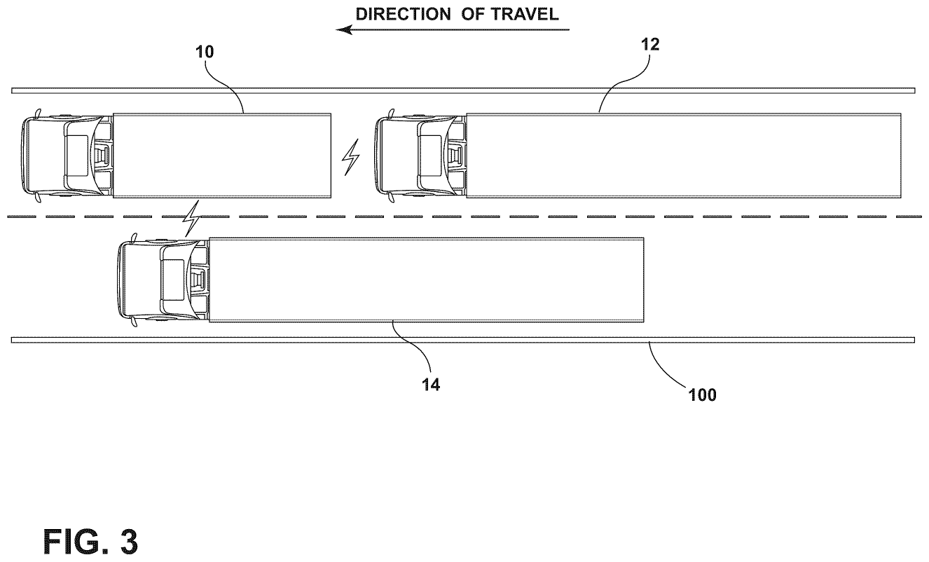

As an alternative to a side-by-side charging configuration, the dual dynamic wireless charging system can include a lead-and-follow configuration, generally shown in FIG. 2. In a lead-and-follow configuration, the transmitter vehicle 10 assumes the role of the leader, and the receiver vehicle 12 follows closely behind. Alternatively, the receiver vehicle 12 can assume the role of the leader, and the transmitter vehicle 10 follows closely behind. In these configurations, the lead vehicle not only provides or receives wireless energy transfer, but also sets pace and trajectory for the following vehicle. Still further alternatively, the transmitter vehicle 10 can provide wireless energy transfer to two or more receiver vehicles 12, 14 simultaneously. As optionally shown in FIG. 3, the transmitter vehicle 10 is longitudinally offset from a first receiver vehicle 12 and laterally offset from a second receiver vehicle 14. When travelling at highway speeds, a side-by-side configuration is generally preferable in order to maintain a safe stopping distance for each vehicle. In a side-by-side configuration, the inter-vehicle distance can be less than 41 inches, still further optionally less than 24 inches, for efficient energy transfer.

Dual dynamic wireless charging is well suited for line-hauling freight. As discussed below, this approach eliminates the need for extended charging stops, thereby enhancing operational efficiency and maximizing uptime for logistics operations. By pre-positioning transmitter vehicles along the intended freight route, heavy duty trucks can maintain smaller onboard batteries, reducing weight and increasing cargo capacity. Suitable receiver vehicles can include, for example, battery electric vehicles (BEVs), fuel cell electric vehicles (FCEVs), hybrid-electric vehicles (HEVs), and other battery-dominant vehicles, whether now known or hereinafter developed. The present invention is not limited to highway applications, however, as dual dynamic wireless charging is well suited for public transmit and passenger vehicles.

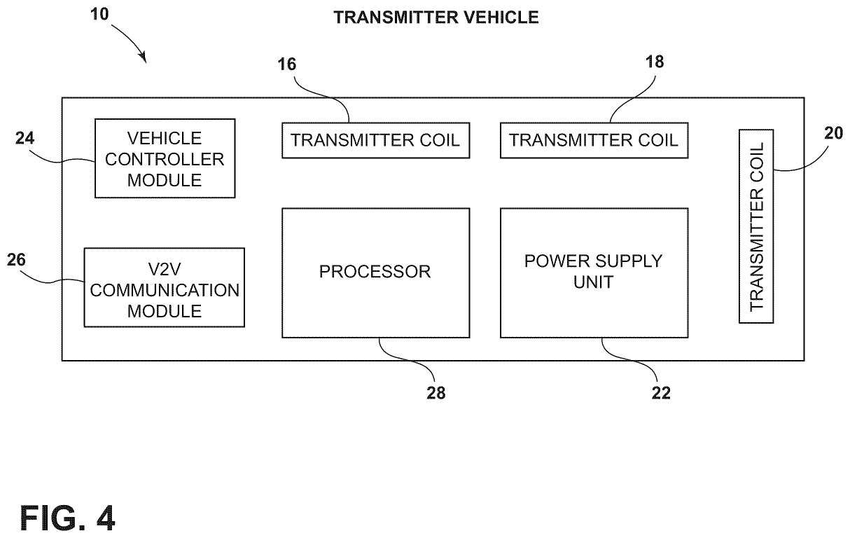

Referring now to FIG. 4, a system block diagram of an exemplary transmitter vehicle 10 is illustrated. The transmitter vehicle 10 includes one or more transmitter coils 16, 18, 20, a power supply unit 22, a vehicle controller module 24, a vehicle-to-vehicle communication module 26, and a processor 28. Generally, the processor 28 includes instructions in machine readable memory that, when executed, cause the power supply unit 22 to generate a time-varying electrical current in a transmitter coil, such that a corresponding time-varying electrical current can be generated in a receiver coil in an adjacent receiver vehicle by electromagnetic induction. The processor 28 is also configured to cause the transmitter vehicle 10 to detect and maintain a predetermined alignment with the receiver vehicle 12 during the transfer of power from the transmitter vehicle 10 to the receiver vehicle 12 while the transmitter vehicle 10 and the receiver vehicle 12 are traversing a roadway. Each such component is separately discussed below.

The transmitter coils 16, 18, 20 are generally configured to generate a time-varying electromagnetic field for transferring power to a nearby receiver coil. For example, the transmitter coils can include the polyphase wireless power transfer system set forth in WO2020/142621, the disclosure of which is incorporated by reference in its entirety. In another embodiment, each transmitter coil 16, 18, 20 comprises a planar conductive winding mounted to a side-panel or -end-panel of the transmitter vehicle. The transmitter coils are optionally steerable, such that they can be canted or rotated to geometrically align with one or more receiver coils in the receiver vehicle 12. Each transmitter coil is electrically coupled to a power supply unit 22. The power supply unit 22 comprises one or more source batteries and suitable power electronics for converting a DC voltage from the source batteries into a high-frequency, time-varying current for the transmitter coils. Suitable source batteries can include, for example, lithium-ion batteries. In still other embodiments the power supply unit 22 includes a fuel cell for converting a source of fuel (e.g., gaseous hydrogen) into electricity for powering the one or more transmitter coils 16, 18, 20.

The vehicle controller module 24 is configured to maintain a precise speed and trajectory of the transmitter vehicle 10. In some embodiments, the vehicle controller module 24 integrates data from multiple sensors, including GPS, lidar, radar, and cameras, to monitor the relative position and movement of the receiver vehicle 12. Using known adaptive cruise-control and lane-keeping algorithms, the vehicle controller module 24 dynamically adjusts the transmitter vehicle's speed and steering to ensure a transmitter coil remains aligned with a receiver coil in the receiver vehicle 12. The vehicle controller module 24 is optionally part of an advanced driver assistance system (ADAS) for SAE level 1 (driver assistance) and level 2 (partial automation). Still further optionally, the vehicle controller module 24 is optionally part of an autonomous drive system for SAE level 3 through 5 (conditional and fully autonomy).

The vehicle controller module 24 can also communicate in real time with the receiver vehicle 12 via a vehicle-to-vehicle communications interface. As part of the vehicle-to-vehicle communications interface, the transmitter vehicle 10 includes a vehicle-to-vehicle communications module 26. The communications module 26 optionally includes a dedicated short-range communications (DSRC) device or a cellular vehicle-to-everything (C-V2X) device. Through this communications module 26, the transmitter vehicle 10 and the receiver 12 vehicle exchange critical information such as battery status, speed, and route. The communications module 26 also helps both vehicles synchronize their movements and adapt to changing road and traffic conditions, ensuring the wireless charging process is uninterrupted while in motion.

As also shown in FIG. 4, the transmitter vehicle 10 includes a processor 28. The processor 28 is communicatively coupled to the power supply unit 22, the vehicle controller module 24, and the communications module 26. The processor 28 is configured to perform several functions as part of the wireless power transfer system. For example, the processor 28 obtains the charging range of the transmitter coil, the footprint of the receiver coil, the inter-vehicle distance, and the relative velocity of the two vehicles 10, 12. Upon receiving a notification from the communications module 26 that the receiver vehicle 12 requires charging, the processor 28 instructs the vehicle controller module 24 to adjust the intra-vehicle distance and the relative velocity. These adjustments ensure that the transmitter coil is positioned within the charging range and that the footprint of the transmitter coil at least partially overlaps with the footprint of the receiver coil. The processor 28 also causes a transmitter coil(s) 16, 18, 20 to operate in a power transfer mode, enabling wireless power transfer while the vehicles 10, 12 are suitably aligned.

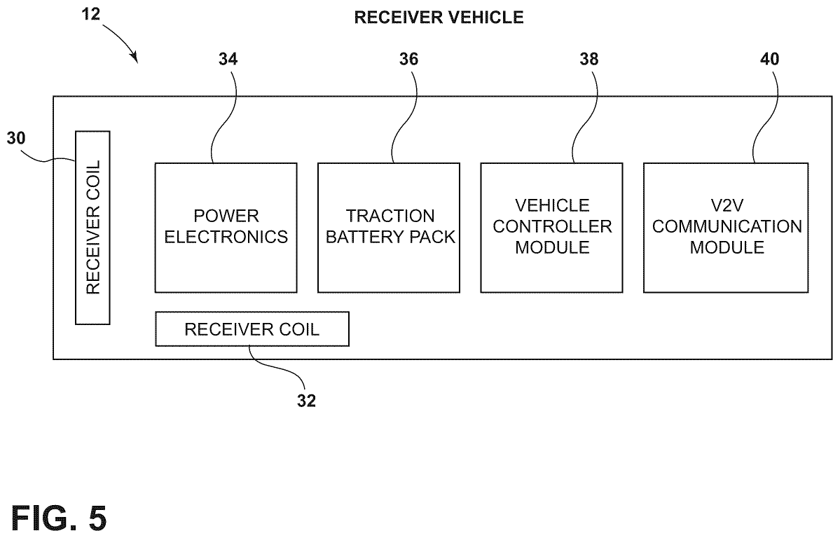

Referring now to FIG. 5, a system block diagram of an exemplary receiver vehicle 12 is illustrated. The receiver vehicle 10 includes one or more receiver coils 30, 32, power electronics 34, a traction battery 36, a vehicle controller module 38, and a vehicle-to-vehicle communication module 40. Each such component is separately discussed below.

The receiver coils 30, 32 are configured to inductively couple to one or more transmitter coils 16, 18, 20 of the transmitter vehicle 10. The receiver coils 30, 32 are optionally planar conductive winding mounted to a side-panel or an end-panel of the receiver vehicle 12. More particularly, the receiver coils 30, 32 are optionally flat, multi-turn, resonant windings. The present invention is not limited to any one configuration, however, as the spacing, size, and orientation of the receiver coils can be selected based on the intended application. The receiver coils are optionally steerable, such that they can be canted or rotated to geometrically align with one or more transmitter coils. Each receiver coil is electrically coupled to power electronics 34. The power electronics 34 is configured to convert a time-varying current generated in the receiver coil into a DC voltage for the traction battery pack 36. Suitable power electronics can include, for example, a rectifier stage, a power factor correction stage, and a DC/DC converter stage, such that the input to the traction battery pack 36 is consistently maintained at a desired voltage, e.g., 400V.

The traction battery pack 36 is a high-capacity energy storage system designed to provide a motive force for the receiver vehicle 12, optionally a battery electric vehicle. For example, the traction battery pack 36 can comprise multiple battery cells, as many as six or more, optionally lithium-ion battery cells. Depending on the given application, the battery cells can provide a storage capacity of 500 kWh or more. For example, six battery cells having a storage capacity of 100 kWh can provide 600 kWh of storage (when connected in parallel). The present invention is not limited to battery electric vehicles, however. In other embodiments, the traction battery pack 36 provides energy for a fuel cell electric vehicle or a hybrid electric vehicle. The availability of mobile charging can result in even smaller onboard batteries, reducing weight and increasing cargo capacity, which is particularly important for long-haul freight operations.

The vehicle controller module 38 is configured to maintain a precise speed and trajectory of the receiver vehicle 12. Similar to the transmitter vehicle's controller module 24, the receiver vehicle's controller module 38 integrates data from multiple sensors, including GPS, lidar, radar, and cameras, to maintain alignment during power transfer. During autonomous driving operations, the vehicle controller module 38 dynamically adjusts the receiver vehicle's speed and steering to ensure a receiver coil remains aligned with a transmitter coil in the transmitter vehicle.

Lastly, the receiver vehicle's communications module 40 can communicate in real time with the transmitter vehicle's communication module 26. Like the transmitter vehicle's communication module 26, the receiver vehicle's communications module 40 optionally includes a DSRC device or a C-V2X device. Through this communications interface, the transmitter vehicle 10 and the receiver 12 vehicle exchange data such as battery status, speed, and route. The communications module 40 also helps both vehicles synchronize their movements and adapt to changing road and traffic conditions, ensuring the wireless charging process is uninterrupted.

In some applications, the transmitter vehicle 10 will originate at a charging depot along an intended route for one or more receiver vehicles 12. After mobile recharging of the receiver vehicle(s), the transmitter vehicle 10 can be re-charged in one of three ways: (a) stationary charging; (b) swapping spent battery modules with fully charged battery modules; or (c) swapping the charging trailer with a new charging trailer containing fully charged battery modules.

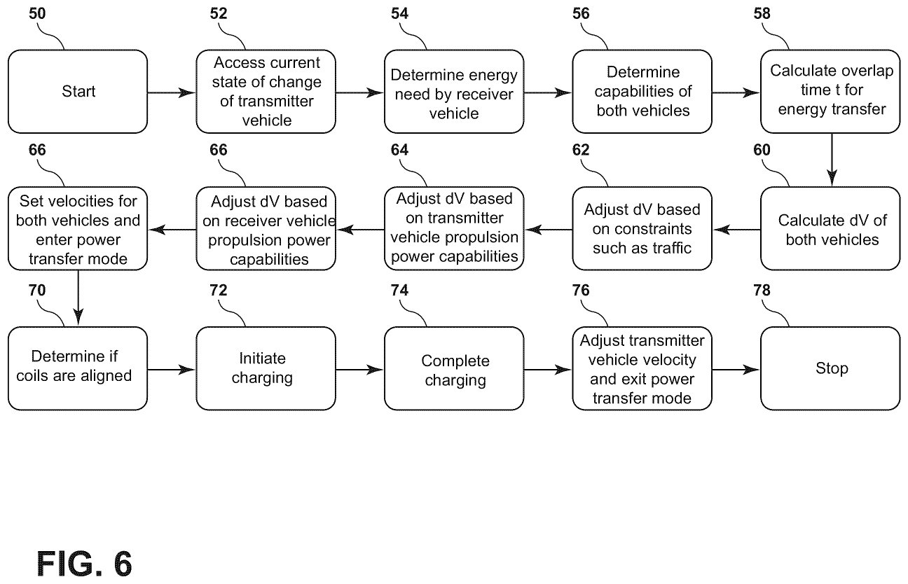

Referring now to FIG. 6, a flow chart for one method of operation is provided, the method of operation being performed by the processor 28. The method begins at step 50 and includes an initial assessment of the state of charge of the transmitter vehicle at step 52. For example, the receiver vehicle 12 monitors and calculates the state of charge and transmits this information to the transmitter vehicle 10 via the vehicle-to-vehicle communications interface. The method also includes an initial determination of the energy level required by the receiver vehicle at step 54 and a determination of the power transfer capabilities of both vehicles at step 56. For step 54, the processor 28 can evaluate a range of factors, including the weight of the receiver vehicle, the distance to the intended destination or to a subsequent transmitter vehicle depot, the aerodynamic drag of the receiver vehicle, the charge and discharge efficiency of the battery of the receiver vehicle, and real-time traffic conditions along the intended route. At step 58, the processor calculates the overlap time t for energy transfer, and at step 60, the processor calculates the relative velocity dV of the transmitter vehicle and the receiver vehicle. The overlap time can be calculated by dividing the overlapping length of the coils (in meters) by the relative velocity dV (in meters per unit time) of the transmitter vehicle and the receiver vehicle.

At step 62, the processor 28 reduces the relative velocity dV to maximize the time t for energy transfer. The processor 28 also adjusts the relative velocity dV based on the propulsion capabilities of the transmitter vehicle at step 64 and based on the propulsion capabilities of the receiver vehicle at step 66. At step 68, the processor 28 sets the velocity for both vehicles via the respective controller modules 24, 38 and enters a power transfer mode.

At step 70, the processor 28 determines if the coils are aligned. This operation can include the use of machine vision systems and/or vehicle-to-vehicle communications, by non-limiting example. For machine vision systems, the transmitter vehicle 10 can use visual markers or patterns on the receiver vehicle 12 to assess alignment. The processor 28 is also configured to determine the overlap between the electromagnetic footprints of the transmitter and receiver coils, optionally using data from both vehicles about the position and dimension of the respective windings. As used herein, the footprint of the transmitter coil refers to the area of the magnetic field generated by the transmitter coil where effective power transfer can occur. Similarly, the footprint of the receiver coil refers to the area within which the receiver coil can effectively capture energy from the transmitter coil's magnetic field. A wider or adaptable footprint can help accommodate minor misalignments to ensure continuous, efficient power transfer.

If the inter-vehicle distance is within an acceptable range, and if the footprints overlap, the processor initiates charging at step 72. During charging, the transmitter vehicle 10 generates a time-varying current in the transmitter coil(s) 16, 18, 20, which induces a corresponding time-varying current in the receiver coil(s) 30, 32. The power electronics module 30 converts this time-varying current into a suitable voltage for recharging the traction battery 36 of the receiver vehicle 12. At step 74, charging is complete, as indicated to the processor 28 via the receiver vehicle's communication module. At step 76, the processor 28 adjusts the transmitter vehicle's velocity and/or route and exits the power transfer mode, ending at step 78.

It should also be noted that traffic is an important factor during wireless charging operations. Based on the knowledge of the traffic density, the number of lanes, and the road profile, the speed of both vehicles may be adjusted not only to meet energy transfer needs, but also to reduce the impact on traffic. The present invention is not limited to dynamic wireless charging, as the transmitter vehicle 10 can provide power to a receiver vehicle 12 while parked. In addition, the transmitter vehicle 10 can prioritize receiver vehicles 12 for dynamic energy transfer, potentially as part of a convoy of receiver vehicles. For example, priority may be based on mission criticality (e.g., high, medium, low), battery state of charge (e.g., high, medium, low), and the next opportunity for recharging along the intended route (e.g., soon, moderate, far). By dynamically evaluating these and other parameters, the processor ensures efficient energy allocation from the transmitter vehicle to support the operational needs of multiple receiver vehicles.

In these and other embodiments, the dual dynamic wireless charging system employs principles of electromagnetic induction to transfer energy without direct physical contact. Because the transmitter vehicle is functionally a mobile charging station, the dual dynamic wireless charging system can operate while both vehicles are in motion, reducing dependency on traditional charging stations. This approach eliminates the need for extended charging stops, thereby enhancing operational efficiency and maximizing uptime for logistics operations. The present invention is particularly well-suited for heavy-duty commercial freight. By pre-positioning transmitter vehicles along an intended freight route, heavy-duty trucks can maintain smaller onboard batteries, reducing weight and increasing cargo capacity.

While primarily directed to freight transport, embodiments of the invention are also well-suited for public transit and passenger vehicles. Off-highway applications are also contemplated. One such off-highway solution includes the charging of parked receiver vehicles, optionally at a refueling depot along an electrified charging corridor, further optionally at a delivery depot. In this embodiment, the transmitter vehicle traverses the row of parked receiver vehicles for providing wireless power substantially as discussed above. As the transmitter vehicle passes each receiver vehicle, the transmitter vehicle transfers power wirelessly to recharge the receiver vehicle's battery. Once charging for that receiver vehicle is complete, the transmitter vehicle proceeds to the next receiver vehicle, thereby eliminating inefficiencies associated with moving vehicles to fixed charging stations. This embodiment leverages a single, mobile charging platform to service multiple vehicles, thus reducing infrastructure costs as compared to traditional systems which require individual charging bays for each parked receiver vehicle.

The above description is that of current embodiments of the invention. Various alterations and changes can be made without departing from the spirit and broader aspects of the invention as defined in the appended claims, which are to be interpreted in accordance with the principles of patent law including the doctrine of equivalents. Any reference to elements in the singular, for example, using the articles “a,” “an,” “the,” or “said,” is not to be construed as limiting the element to the singular.

1. A system for wirelessly transferring power from a power source onboard a transmitter vehicle to a battery onboard a receiver vehicle while the transmitter vehicle and the receiver vehicle are moving along a direction of motion along a roadway, the system comprising:
a power transmitter onboard the transmitter vehicle and electrically coupled with the power source, the power transmitter comprising a transmitter coil configured to wirelessly transmit power along a direction that is transverse to or aligned with the direction of motion; and
a power receiver onboard the receiver vehicle and electrically coupled with the battery, the power receiver comprising a receiver coil configured to wirelessly receive power transmitted by the transmitter coil when (i) the transmitter coil is spaced apart from the receiver coil within a charging range and (ii) a footprint of the transmitter coil overlaps with a footprint of the receiver coil.

2. The system of claim 1, further comprising:
a processor communicatively coupled to the power transmitter, a controller module of the transmitter vehicle, and a controller module of the receiver vehicle, wherein the processor is configured to:
obtain the charging range, the footprint of the transmitter coil, the footprint of the receiver coil, an inter-vehicle distance separating at least a portion of the transmitter vehicle from at least a portion of the receiver vehicle, and a relative velocity between the transmitter vehicle and the receiver vehicle,
in response to receiving a notification from the controller module of the receiver vehicle that the battery requests a charge, instruct the controller module of the transmitter vehicle to adjust the inter-vehicle distance and the relative velocity to cause the transmitter coil to be within the charging range and to cause the footprint of the transmitter coil to overlap the footprint of the receiver coil, and
cause the power transmitter to operate in a power transfer mode while the transmitter coil is within the charging range and the while the footprint of the transmitter coil overlaps the footprint of the receiver coil.

3. The system of claim 2, wherein the processor is configured to cause the power transmitter to terminate operation of the power transfer mode after receiving a notification from the controller module of the receiver vehicle that the battery is fully charged.

4. The system of claim 2, wherein the processor is configured to generate instructions for the controller module of the transmitter vehicle.

5. The system of claim 1, wherein the charging range is less than four feet.

6. The system of claim 1, wherein the charging range is less than two feet.

7. The system of claim 1, wherein the processor is disposed onboard the transmitter vehicle.

8. The system of claim 1, wherein the power source comprises one or more source batteries.

9. The system of claim 1, wherein the power source comprises a fuel cell.

10. A convoy comprising:
the system of claim 1;
a plurality of the receiver vehicles; and
at least one of the transmitter vehicle.

11. The convoy of claim 10, wherein each of the plurality of receiver vehicles comprise electric vehicles, and wherein the at least one transmitter vehicle comprises an internal combustion engine.

12. The convoy of claim 10, wherein the plurality of receiver vehicles and the at least one transmitter vehicle comprise autonomous vehicles.

13. The convoy of claim 10, wherein the transmitter vehicle is configurated to prioritize wireless charging among the plurality of receiver vehicles based on battery state of charge and mission criticality for each of the plurality of receiver vehicles.

14. A method for dynamic wireless charging, the method comprising:
positioning a transmitter vehicle in a predetermined alignment with respect to a receiver vehicle while traversing a roadway, wherein the predetermined alignment includes a side-by-side configuration or a lead-and-follow configuration, and wherein the transmitter vehicle includes a transmitter coil and the receiver vehicle includes a receiver coil;
transferring power from the transmitter vehicle to the receiver vehicle by generating a time-varying electrical current in the transmitter coil, such that a corresponding time-varying electrical current is generated in the receiver coil by electromagnetic induction;
converting the time-varying electrical current in the receiver coil into electrical energy for storage in a battery of the receiver vehicle; and
detecting and maintaining the predetermined alignment during the transfer of power from the transmitter vehicle to the receiver vehicle while the transmitter vehicle and the receiver vehicle are traversing the roadway, wherein the detecting and maintaining the predetermined alignment includes adjusting an inter-vehicle distance separating the transmitter vehicle from the receiver vehicle and adjusting a relative velocity of the transmitter vehicle and the receiver vehicle.

15. The method of claim 14, further including terminating the time-varying electrical current in the transmitter coil in response to the battery of the receiver vehicle being fully charged.

16. The method of claim 14, wherein detecting and maintaining the predetermined alignment includes causing a footprint of the transmitter coil to overlap a footprint of the receiver coil.

17. The method of claim 14, wherein detecting and maintaining the predetermined alignment includes maintaining a predetermined lateral and longitudinal distance between the transmitter coil and the receiver coil.

18. The method of claim 14, wherein detecting and maintaining the predetermined alignment includes using global positioning system (GPS) data to track and adjust the relative positions of the transmitter vehicle and the receiver vehicle.

19. The method of claim 14, wherein transferring power from the transmitter vehicle to the receiver vehicle includes dynamically adjusting a power output of the transmitter coil based on energy requirements of the receiver coil.

20. The method of claim 14, further including exchanging data between the transmitter vehicle and the receiver vehicle during the transfer of power to the receiver vehicle.

21. The method of claim 14, wherein detecting and maintaining the predetermined alignment is performed by an autonomous driving system of at least one of the transmitter vehicle and the receiver vehicle.

22. The method of claim 14, further including adjusting the orientation of at least one of the transmitter coil and the receiver coil to optimize the transfer of power to the receiver vehicle.

23. A transmitter vehicle for a dynamic wireless charging system, comprising:
a power transmitter comprising a transmitter coil configured to wirelessly transmit power in a direction that is transverse to or aligned with a direction of motion of the transmitter vehicle;
a power supply unit electrically coupled to the power transmitter, the power supply unit including a source battery or a fuel cell; and
a processor communicatively coupled to the power transmitter and the power supply unit, the processor being configured to:
cause the power supply unit to generate a time-varying electrical current in the transmitter coil, such that a corresponding time-varying electrical current can be generated in a receiver coil in an adjacent receiver vehicle by electromagnetic induction;
cause the transmitter vehicle to detect and maintain a predetermined alignment with the receiver vehicle during a transfer of power from the transmitter vehicle to the receiver vehicle while the transmitter vehicle and the receiver vehicle are traversing a roadway, wherein the detecting and maintaining the predetermined alignment includes adjusting an inter-vehicle distance separating the transmitter vehicle from the receiver vehicle and adjusting a relative velocity of the transmitter vehicle and the receiver vehicle.

24. The transmitter vehicle of claim 22, wherein the processor is further configured to cause the power supply unit to terminate the time-varying electrical current in the transmitter coil in response to a battery of the receiver vehicle being fully charged.

25. The transmitter vehicle of claim 22, further including a communications system for exchanging data between the transmitter vehicle and the receiver vehicle during the transfer of power to the receiver vehicle.

26. The transmitter vehicle of claim 23, wherein the transmitter vehicle is further configured to move along a plurality of stationary receiver vehicles for transferring power thereto without requiring movement of the plurality of receiver vehicles.

27. The transmitter vehicle of claim 26, wherein the transmitter vehicle is further configured to prioritize the transfer of power to various ones of the plurality of stationary receiver vehicles based, at least in part, on a state of charge of the plurality of stationary receiver vehicles.

28. A method for charging a plurality of stationary receiver vehicles, the method comprising:
positioning a transmitter vehicle in alignment with successive ones of the plurality of stationary receiver vehicles, wherein the transmitter vehicle includes a transmitter coil and wherein each of the plurality of stationary receiver vehicles include a receiver coil;
transferring power from the transmitter vehicle to each of the plurality of stationary receiver vehicles by generating a time-varying electrical current in the transmitter coil, such that a corresponding time-varying electrical current is generated in each receiver coil;
for each of the plurality of stationary receiver vehicles, converting the time-varying electrical current in the corresponding receiver coil into electrical energy for a battery; and
detecting and maintaining a predetermined inter-vehicle spacing during the transfer of power from the transmitter vehicle to each of the plurality of stationary receiver vehicles.

29. The method of claim 28, further comprising moving the transmitter vehicle among the plurality of stationary receiver vehicles for transferring power thereto without requiring movement of the plurality of receiver vehicles.

30. The method of claim 28, further comprising prioritizing the transfer of power to various ones of the plurality of stationary receiver vehicles based, at least in part, on a battery state of charge of the plurality of stationary receiver vehicles.
